(19) United States
(12) Patent Application Publication
(10) Pub. No.: US 2020/0234367 A1
(43) Pub. Date: Jul. 23, 2020

(54) VIRTUAL CURRENCY VALUE ESTIMATION METHOD AND APPARATUS, AND STORAGE MEDIUM

(71) Applicant: BEIJING KINGSOFT INTERNET SECURITY SOFTWARE CO., LTD., Beijing (CN)

(72) Inventors: Wenyu Yang, Beijing (CN); Chunmeng Gao, Beijing (CN)

(73) Assignee: BEIJING KINGSOFT INTERNET SECURITY SOFTWARE CO., LTD., Beijing (CN)

(21) Appl. No.: 16/798,921

(22) Filed: Feb. 24, 2020

Related U.S. Application Data
(63) Continuation of application No. PCT/CN2018/103325, filed on Aug. 30, 2018.

(30) Foreign Application Priority Data
Jun. 25, 2018 (CN) 201810661612.3

(51) Int. Cl. G06Q 40/04; G06Q 20/38; G06Q 20/06

(52) U.S. Cl. CPC G06Q 40/04; G06Q 20/065; G06Q 20/389

(57) ABSTRACT

A virtual currency value estimation method and apparatus and a storage medium. The virtual currency value estimation method comprises: acquiring historical transaction information of a blockchain system, wherein the historical transaction information comprises: a user identifier corresponding to each transaction and the number of virtual currencies used in the transaction; determining a head user currently in the blockchain system according to the user identifier corresponding to each transaction and the number of virtual currencies used in the transaction; determining transaction data of the head user within a current preset time period according to transaction information of the blockchain system within the current preset time period; estimating a market value of a virtual currency according to the transaction data within the current preset time period and a current price variation value of the virtual currency.

### CROSS-REFERENCE TO RELATED APPLICATIONS

This application is a continuation application of International Application No. PCT/CN2018/103325, filed on Aug. 30, 2018, which claims priority to and benefits of Chinese Patent Application No. 201810661612.3, filed with the State Intellectual Property Office of P. R. China on Jun. 25, 2018 by BEIJING KINGSOFT INTERNET SECURITY SOFTWARE CO., LTD., entitled “Virtual Currency Value Estimation Method and Apparatus, Electronic Device and Storage Medium”.

### FIELD

The present disclosure relates to a field of computer technologies, and more particularly, to a virtual currency value estimation method and apparatus, and a storage medium.

### BACKGROUND

With the continuous development of Internet technologies, the Internet is no longer just a medium for communication between peoples, and it is a norm in an information society to use the Internet for work, study, entertainment, and shopping. Meanwhile, the Internet has led to an emergence of a new market, which is a virtual market based on cyberspace. In this case, the form of currency is more virtualized, and there are virtual currencies that exist in the form of electronic signals without physical forms. The virtual currencies have greatly exceeded restrictions on space and time in a physical word, which makes it more convenient and fast to use virtual currencies for online consumption, such that a better experience is achieved for users by using virtual currencies to obtain services or make entertainment consumption.

With the rapid development of virtual currencies, types of the virtual currencies are increasing, which can be roughly divided into the following three types. The first type is game currencies in console games; the second type is currencies issued by portals or instant communication tool service providers and used to purchase services in the website, such as Tencent's Q-coins; and the third type is virtual currencies on the Internet, such as Bitcoin and Litecoin, which are mainly used for Internet financial investment, and can also be used as modern currencies and directly used in daily life.

Virtual currencies in the Internet have great investment potential, more and more people hope to increase their wealth by investing in virtual currencies. Therefore, it is imperative to estimate value trends of various virtual currencies and recommend virtual currencies with high value-added potential to users. In the future personalized virtual currency trading market, information such as stock index price levels may also be formed. Currently, the products related to virtual currencies in the market are mainly to provide users with channels for buying and selling virtual currencies and services for unified management of virtual currencies. The function of predicting the value trends of virtual currencies does not yet exist, which increases the investment risk of users.

### SUMMARY

Embodiments of the present disclosure aim to solve at least one of the technical solutions in the related art.

Embodiments of the present disclosure provide a virtual currency value estimation method. The method includes: obtaining historical transaction information of a blockchain system, in which the historical transaction information includes a user identifier corresponding to a transaction and an amount of virtual currency used in the transaction; determining a head user in the blockchain system according to the user identifier corresponding to the transaction and the amount of the virtual currency used in the transaction; determining transaction data of the head user in a current preset time period according to transaction information of the blockchain system in the current preset time period; and estimating a market value of the virtual currency based on the transaction data in the current preset time period and a current price change value of the virtual currency.

Embodiments of the present disclosure provide a virtual currency value estimation apparatus. The apparatus includes: one or more processors; a memory storing instructions executable by the one or more processors; in which the one or more processors are configured to: obtain historical transaction information of a blockchain system, in which the historical transaction information includes a user identifier corresponding to a transaction and an amount of virtual currency used in the transaction; determine a head user in the blockchain system according to the user identifier corresponding to the transaction and the amount of the virtual currency used in the transaction; determine transaction data of the head user in a current preset time period according to transaction information of the blockchain system in the current preset time period; and estimate a market value of the virtual currency based on the transaction data in the current preset time period and a current price change value of the virtual currency.

Embodiments of the present disclosure provide a computer-readable storage medium having a computer program stored thereon. When the program is executed by a processor, the virtual currency value estimation method is implemented as: obtaining historical transaction information of a blockchain system, in which the historical transaction information includes a user identifier corresponding to a transaction and an amount of virtual currency used in the transaction; determining a head user in the blockchain system according to the user identifier corresponding to the transaction and the amount of the virtual currency used in the transaction; determining transaction data of the head user in a current preset time period according to transaction information of the blockchain system in the current preset time period; and estimating a market value of the virtual currency based on the transaction data in the current preset time period and a current price change value of the virtual currency.

Additional aspects and advantages of embodiments of the present disclosure will be given in part in the following descriptions, become apparent in part from the following descriptions, or be learned from the practice of the embodiments of the present disclosure.

### BRIEF DESCRIPTION OF THE DRAWINGS

The above and/or additional aspects and advantages of the present disclosure will become apparent and easily understood from the following description of the embodiments with reference to the accompanying drawings, in which:

FIG. 1 is a flowchart of a virtual currency value estimation method according to an embodiment of the present disclosure.

FIG. 2 is a flowchart of a virtual currency value estimation method according to a specific embodiment of the present disclosure.

FIG. 3 is a schematic diagram of a virtual currency value estimation apparatus according to an embodiment of the present disclosure.

FIG. 4 is a schematic diagram of an electronic device according to an embodiment of the present disclosure.

### DETAILED DESCRIPTION

Reference will be made in detail to embodiments of the present disclosure. Embodiments of the present disclosure will be shown in drawings, in which the same or similar elements and the elements having same or similar functions are denoted by like reference numerals throughout the descriptions. The embodiments described herein according to drawings are explanatory and illustrative, not construed to limit the present disclosure.

In addition, terms such as “first” and “second” are used herein for purposes of description and are not intended to indicate or imply relative importance or significance. Thus, the feature defined with “first” and “second” may comprise one or more this feature. In the description of the present disclosure, “a plurality of” means at least two, for example, two or three, unless specified otherwise.

Any process or method described in a flow chart or described herein in other ways may be understood to include one or more modules, segments or portions of codes of executable instructions for achieving specific logical functions or steps in the process, and the scope of a preferred embodiment of the present disclosure includes other implementations, which should be understood by those skilled in the art.

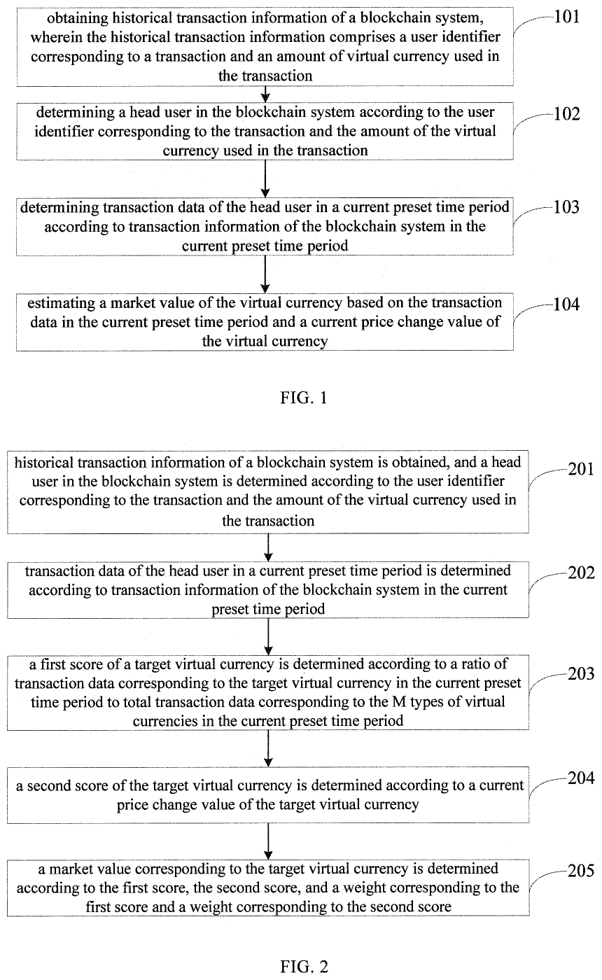

FIG. 1 is a flowchart of a virtual currency value estimation method according to an embodiment of the present disclosure.

As illustrated in FIG. 1, the virtual currency value estimation method includes the followings.

At step 101, historical transaction information of a blockchain system is obtained, in which the historical transaction information includes a user identifier corresponding to a transaction and an amount of virtual currency used in the transaction.

In actual use, the virtual currency value estimation method according to the embodiments of the present disclosure may be implemented by the virtual currency value estimation apparatus according to the embodiments of the present disclosure. The virtual currency value estimation apparatus may be configured in any electronic device, such as a mobile phone, a computer and the like.

The blockchain system refers to a new application mode of computer technologies such as distributed data storage, point-to-point transmission, consensus mechanism, and encryption algorithms. The consensus mechanism is a mathematical algorithm in the blockchain system to establish trust and obtain rights among different nodes. Blockchain is an important concept of virtual currency and is essentially a decentralized database and serves as an underlying technology of virtual currency at the same time. A blockchain is a series of data blocks that are generated by using cryptographic methods. Each data block contains information on a virtual currency network transaction, which is used to verify the validity of its information (anti-counterfeiting) and generate the next block. Each block contains a timestamp and a link to the previous block. In a narrow sense, the blockchain is a chain data structure that combines data blocks connected sequentially in a chronological order, and a cryptographically guaranteed tamper-proof and unforgeable distributed ledger, that is, once the data in the blockchain is recorded, it is irreversible.

The user identity refers to the user's identity authentication information. Understandably, each user has a unique user identity. For example, it can be a software account of a user when conducting virtual currency transactions.

It is understood that all historical transaction information of virtual currencies is stored in the blockchain system and cannot be tampered with or forged, thus the information has high reliability. Therefore, the virtual currency value estimation apparatus according to the embodiments of the present disclosure can obtain historical transaction information of virtual currencies from the blockchain system.

At step 102, a head user in the blockchain system is determined according to the user identifier corresponding to the transaction and the amount of the virtual currency used in the transaction.

The head user refers to one or more users holding the largest number of virtual currencies in the current blockchain system.

In actual use, the number of head users can be determined according to actual requirements, which is not limited in the embodiments of the present disclosure. For example, the top 10,000 users holding the largest number of virtual currencies in the blockchain system can be selected as head users.

Further, in a possible implementation of the embodiments of the present disclosure, the blockchain system may include various types of virtual currencies, such as Bitcoin, Litecoin, Dogecoin, and Dashcoin. In other words, the block chain system includes N types of virtual currencies.

It should be noted that when the blockchain system includes various types of virtual currencies, the historical transaction information further includes a type of the virtual currency used in each transaction. Correspondingly, when the blockchain system includes various types of virtual currencies, the head users may be determined according to the total value of the virtual currencies held by the users. That is, in a possible implementation of embodiments of the present disclosure, the above step 102 may include: obtaining N legal tender prices corresponding to the N types of virtual currencies respectively; and determining the head user according to the N legal tender prices corresponding to the N types of virtual currencies and a number of the N types of virtual currencies occupied by each user in the blockchain system.

Legal tender refers to the real currency circulating in the real society, which can be used as a standard for measuring the value of virtual currency. In other words, the price of legal tender corresponding to virtual currency refers to the value of the virtual currency.

It should be noted that in the blockchain system, when a user holds various types of virtual currencies, the total value of the virtual currencies held by the user can be determined according to the amount of each type of virtual currency and the current legal tender price of each type of virtual currency, and then one or more users with the largest total value of the held virtual currency are determined as head users.

It is understood that the total value of the virtual currencies held by the user refers to the sum of the product of the amount of each type of virtual currency held by the user and the current legal tender price of each type of virtual currency.

For example, user A in the current blockchain system holds 100 bitcoins and 150 litecoins. The current legal tender price of 1 bitcoin is 2 thousand, and the current legal tender price of 1 litecoin is 1 thousand, then the total value of the virtual currencies held by the user A is 100×2000+150×1000=0.35 million.

At step 103, transaction data of the head user in a current preset time period is determined according to transaction information of the blockchain system in the current preset time period.

The transaction information may include information such as a user identity of a user who performs a transaction, a transaction time, a type of virtual currency used during the transaction, and transaction data. Transaction data refers to a difference between the amount of virtual currency that the user earns and the amount of virtual currency that is spent. When the amount of virtual currency that the user earns is greater than the amount of virtual currency that is spent, the transaction data is positive, otherwise, the transaction data is negative.

It should be noted that, because the head user is the user with the largest total value of the virtual currencies held in the blockchain system, the head user can generally be regarded as an experienced group in the virtual currency trading market. The type of the virtual currency held by the head user can be considered to have a high market value, that is, the transaction changes of the head user can be monitored in real time to predict the value trend of the virtual currency.

In a possible implementation of the present disclosure, the transaction information of the head user can be monitored in real time by presetting the specific time when the transaction information of the blockchain system is obtained. For example, the time to obtain the transaction information of the blockchain system can be determined as on the hour, that is, the transaction information is obtained every hour, and the transaction information obtained at 9:00 is the transaction information of the blockchain system from 8:00 to 9:00.

It should be noted that when users use virtual currency for transactions, each time a new transaction is generated, a new block is added to the blockchain system to record the transaction information of the transaction this time. Therefore, in a possible implementation of the embodiment of the present disclosure, the transaction information of the blockchain system within the current preset time period may be determined according to the transaction information in the new block. In other words, before the foregoing step 103, the method may further include: determining a new block in the blockchain system; and determining the transaction information of the blockchain system in the current preset time period according to transaction information of the new block in the current preset time period.

Each block in the blockchain system includes a time stamp, and the time stamp refers to the time when the block is generated, that is, the time when the transaction recorded in the block is generated. Therefore, in a possible implementation of the embodiment of the present disclosure, a new block within a preset time period may be determined according to whether the time stamp in the block is within a preset time period, and then based on the transaction information in the new block in the current preset time period, the transaction information of the blockchain system in the current preset time period is determined.

It is understood that after the transaction information of the blockchain system within the current preset time period is determined, the transaction data of the head user within the current preset time period can be determined according to the user identifier of the head user.

Furthermore, the blockchain system may include various types of virtual currencies. In a possible implementation of the embodiments of the present disclosure, the transaction data of the head user in the current preset time period includes transaction data corresponding to M types of virtual currencies in the current preset time period, and M is an integer less than or equal to N.

It is understood that, in a possible implementation of the embodiments of the present disclosure, the type of virtual currency held by the head user may only be part of all virtual currency types in the blockchain system, that is, the total number of types of virtual currency held by the head user is less than or equal to the total number of all types of virtual currency in the blockchain system. When the total number of types of virtual currency held by the head user is less than or equal to the total number of types of virtual currency in the blockchain system, that is, when M is less than N, only the transaction data of the virtual currency held by the head user in the current preset time period can be determined.

For example, the current blockchain system includes three types of virtual currencies: Bitcoin, Litecoin, and Dashcoin, and the determined types of currencies held by the head user are only two types of virtual currencies: Bitcoin and Litecoin. Then, at this time, only the transaction data corresponding to Bitcoin and Litecoin within the current preset time period may be determined.

At step 104, a market value of the virtual currency is estimated based on the transaction data in the current preset time period and a current price change value of the virtual currency.

The current value change of the virtual currency refers to a change value of the price of the virtual currency in the current preset time period, and the price of the virtual currency in the previous preset time period adjacent to the current preset time period.

It should be noted that the transaction data can be determined based on the difference between the amount of virtual currency the user earns and the amount of virtual currency that is spent. When the amount of virtual currency the user earns is greater than the amount of virtual currency that is spent, the transaction data is positive, otherwise, the transaction data is negative. If the head user's transaction data for a certain type of virtual currency is positive, it can be considered that the market value of this type of virtual currency is high, otherwise, it can be considered that the market value of this type of virtual currency is low. Correspondingly, the larger the head user's transaction data for a certain type of virtual currency, that is, the more the amount of virtual currency the user earns relative to the amount of virtual currency that is spent, the higher the market value of the virtual currency; otherwise, the lower the market value of the virtual currency.

For example, there are three types of virtual currencies currently held by a head user, i.e., Bitcoin, Litecoin, and Dashcoin. The income amount of the Bitcoin is 500, and the outcome amount of the Bitcoin is 100. The income amount of the Litecoin is 400, and the outcome amount of the Litecoin is 150. The income amount of the Dashcoin is 50, and the outcome amount of the Dashcoin is 200. Then, it can be considered that the market value of Bitcoin and Litecoin is higher, while the market value of Dashcoin is lower, and the market value of Bitcoin is greater than the market value of Litecoin.

It is understood that the current price change value of the virtual currency can also reflect the market value of the virtual currency. The price of the virtual currency in the current preset time period is compared with the price of the virtual currency in the previous preset time period adjacent to the current preset time period, when the price of virtual currency rises, it can be considered that the market value of virtual currency is increased; otherwise, the market value of virtual currency is decreased.

In a possible implementation of the embodiments of the present disclosure, the transaction data in the current preset time period and the current price change value of the virtual currency may be comprehensively considered to estimate the market value of the virtual currency.

With the virtual currency value estimation method according to embodiments of the present disclosure, historical transaction information of a blockchain system is obtained, a head user in the blockchain system is determined according to the user identifier corresponding to the transaction and the amount of the virtual currency used in the transaction, transaction data of the head user in a current preset time period is determined according to transaction information of the blockchain system in the current preset time period, and a market value of the virtual currency is estimated based on the transaction data in the current preset time period and a current price change value of the virtual currency. Therefore, the head user in the blockchain system is determined based on the historical transaction information of the blockchain system, and then the market value of the virtual currency can be estimated based on the transaction data of the head user and the current price change value of the virtual currency, thereby realizing real-time prediction of the value trend of virtual currencies and reducing the investment risk of users.

FIG. 2 is a flowchart of a virtual currency value estimation method according to a specific embodiment of the present disclosure.

As illustrated in FIG. 2, the virtual currency value estimation method includes the following steps.

At step 201, historical transaction information of a blockchain system is obtained, and a head user in the blockchain system is determined according to the user identifier corresponding to the transaction and the amount of the virtual currency used in the transaction.

At step 202, transaction data of the head user in a current preset time period is determined according to transaction information of the blockchain system in the current preset time period.

For specific implementation processes and principles of steps 201-202, reference may be made to the detailed description of the foregoing embodiments, and details are not described herein again.

At step 203, a first score of a target virtual currency is determined according to a ratio of transaction data corresponding to the target virtual currency in the current preset time period to total transaction data corresponding to the M types of virtual currencies in the current preset time period.

The target virtual currency refers to the virtual currency whose current market value needs to be estimated. The M types of virtual currencies refer to the types of virtual currencies currently held by the head user. The first score of the target virtual currency refers to a factor that measures the market value of the target virtual currency.

It should be noted that, in the embodiments of the present disclosure, the blockchain system includes N types of virtual currencies, and M is an integer less than or equal to N. In other words, the types of virtual currencies held by the head user may be part of all types of virtual currencies in the blockchain system, or it may include all types of virtual currencies in the blockchain system.

It can be understood that, in the embodiments of the present disclosure, the head users, as the group with the largest total value of virtual currency held in the blockchain system and experienced in the virtual currency trading market, it can be considered that the types of virtual currencies held by the head users have high market value, and other types of virtual currencies in the blockchain system that are not held by the head users can be considered to have a low market value. Therefore, in the embodiments of the present disclosure, the market value of only M types of virtual currencies held by the head user can be estimated.

In a possible implementation of the embodiments of the present disclosure, the transaction data corresponding to the virtual currency may be used as a factor reflecting its market value. Further, in order to ensure the reliability of the estimated virtual currency market value, a ratio of transaction data corresponding to the target virtual currency in the current preset time period to total transaction data corresponding to the M types of virtual currencies held by the head users in the current preset time period is used as the first score of the target virtual currency.

At step 204, a second score of the target virtual currency is determined according to a current price change value of the target virtual currency.

The second score of the target virtual currency refers to another factor that measures the market value of the target virtual currency.

It should be noted that the current price change value of the target virtual currency refers to the current value change of the legal tender corresponding to the target virtual currency. Therefore, the current price change value of the target virtual currency can be determined according to the price of the legal tender corresponding to the target virtual currency in the current preset time period and the price of the legal tender corresponding to the target virtual currency in the previous preset time period. That is, in a possible implementation of the present disclosure, before step 204, the method may further include: determining a first legal tender price corresponding to the virtual currency in the current preset time period, and a second legal tender price corresponding to the virtual currency in a previous preset time period adjacent to the current preset time period; and determining the current price change value of the virtual currency according to the first legal tender price and the second legal tender price.

It should be noted that, in a possible implementation of the embodiment of the present disclosure, the price change value of the virtual currency may be the difference between the first legal tender price and the second legal tender price of the virtual currency. When the first legal tender price is greater than the second legal tender price, the current price change value of the virtual currency is positive, and the market value of the virtual currency increases; otherwise, the market value of the virtual currency decreases.

For example, the virtual currency is Bitcoin, and the current preset time period is 9:00-10:00, then the previous preset time period adjacent to the current preset time period is 8:00-9:00, and the first legal tender price of the Bitcoin during the period from 9:00 to 10:00 is 1050 RMB, and the second legal tender price of the Bitcoin during the period from 8:00 to 9:00 is 1,000 RMB. Then, the current price change of bitcoin is 1050−1000=50 RMB, and the market value of Bitcoin rises.

At step 205, a market value corresponding to the target virtual currency is determined according to the first score, the second score, and a weight corresponding to the first score and a weight corresponding to the second score.

It should be noted that because the first score and the second score corresponding to the target virtual currency are important factors to measure their corresponding market value, the first score and the second score can be considered comprehensively for the target virtual currency market value, and appropriate weights can be set for the first score and the second score to determine the market value of the target virtual currency.

In a possible implementation of the embodiments of the present disclosure, the market value of the target virtual currency can be determined according to the following formula (1).

$$score ( R ) = {α}_{1} \cdot \frac{{\sum }_{Tx} R}{{\sum }_{Tx} {C}_{i}} + {α}_{2} \cdot ( {P}_{1} - {P}_{0} ) \qquad ( 1 )$$

where R refers to the type of the target virtual currency, Cᵢ refers to all types of the currencies held by the head user, Σ_{Tx}R refers to the transaction data of the target virtual currency, and Σᵢ₌₁^{M}Σ_{Tx}Cᵢ is the total transaction data corresponding to the M types of virtual currencies held by the head user, P₁ is the first legal tender price corresponding to the target virtual currency, and P₀ is the second legal tender price corresponding to the target virtual currency, α₁ is the weight of the first score, and α₂ is the weight of the second score.

In a possible implementation of the embodiments of the present disclosure, α₁+α₂=1, the specific value of α₁ and α₂ can be determined based on actual conditions, which is not limited herein. For example, α₁=0.6, α₂=0.4. It is understood that the larger the score value of the target virtual currency determined according to formula (1), the greater the market value corresponding to the virtual currency.

It should be noted that formula (1) is only an exemplary description of the embodiment of the present disclosure, and cannot be regarded as a limitation on the present disclosure.

Further, the market value of all types of virtual currencies in the blockchain system can also be determined according to the above method, that is, in a possible implementation of the embodiments of the present disclosure, the above step 205 may further include: estimating market values of the N types of virtual currencies respectively.

Further, after estimating the market values of the N types of virtual currencies included in the blockchain system, one or more virtual currencies with the largest corresponding market value can be selected and recommended to the user. That is, in a possible implementation of this embodiment of the present disclosure, after the foregoing step 205, the method may further include: determining a target virtual currency to be recommended to the user according to the market values of the N types of virtual currencies.

The target virtual currency to be recommended to the user refers to one or more virtual currencies corresponding to the largest market value. In actual use, the amount of target virtual currencies to be recommended to the user may be determined according to actual needs, which is not limited herein.

With the virtual currency value estimation method according to embodiments of the present disclosure, historical transaction information of a blockchain system is obtained, a head user in the blockchain system is determined according to the user identifier corresponding to the transaction and the amount of the virtual currency used in the transaction, transaction data of the head user in a current preset time period is determined according to transaction information of the blockchain system in the current preset time period. Furthermore, according to the transaction data in the current preset time period and the current price change value of the virtual currency, the first score and the second score corresponding to the target virtual currency are determined, and a weight of the first score and a weight of the second score are set appropriately to estimate the market value of the target virtual currency. Therefore, the head user in the blockchain system is determined based on the historical transaction information of the blockchain system, and then the market value of the virtual currency can be estimated based on the transaction data of the head user and the current price change value of the virtual currency, thereby realizing real-time prediction of the value trend of virtual currencies and reducing the investment risk of users.

To achieve the above embodiments, the present disclosure further provides a virtual currency value estimation apparatus.

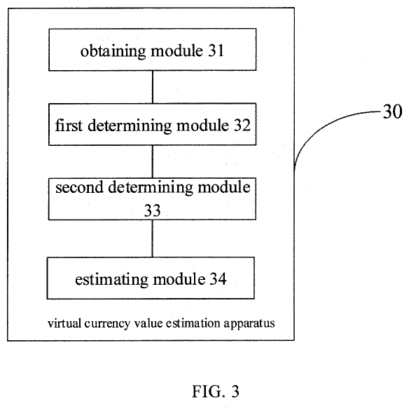

FIG. 3 is a schematic diagram of a virtual currency value estimation apparatus according to an embodiment of the present disclosure.

As illustrated in FIG. 3, the virtual currency value estimation apparatus 30 includes: an obtaining module 31, configured to obtain historical transaction information of a blockchain system, in which the historical transaction information includes a user identifier corresponding to a transaction and an amount of virtual currency used in the transaction; and the historical transaction information further includes a type of the virtual currency used in the transaction; a first determining module 32, configured to determine a head user in the blockchain system according to the user identifier corresponding to the transaction and the amount of the virtual currency used in the transaction; and a second determining module 33, configured to determine transaction data of the head user in a current preset time period according to transaction information of the blockchain system in the current preset time period, in which the transaction data of the head user in the current preset time period includes transaction data corresponding to M types of virtual currencies in the current preset time period, and M is an integer less than or equal to N; and an estimating module 34, configured to estimate a market value of the virtual currency based on the transaction data in the current preset time period and a current price change value of the virtual currency.

In actual use, the virtual currency value estimation apparatus according to the embodiments of the present disclosure may be configured in any electronic device to execute the foregoing virtual currency value estimation method.

With the virtual currency value estimation apparatus according to embodiments of the present disclosure, historical transaction information of a blockchain system is obtained, a head user in the blockchain system is determined according to the user identifier corresponding to the transaction and the amount of the virtual currency used in the transaction, transaction data of the head user in a current preset time period is determined according to transaction information of the blockchain system in the current preset time period, and a market value of the virtual currency is estimated based on the transaction data in the current preset time period and a current price change value of the virtual currency. Therefore, the head user in the blockchain system is determined based on the historical transaction information of the blockchain system, and then the market value of the virtual currency can be estimated based on the transaction data of the head user and the current price change value of the virtual currency, thereby realizing real-time prediction of the value trend of virtual currencies and reducing the investment risk of users.

In a possible implementation of the embodiments of the present disclosure, the first determining module 32 includes: an obtaining unit, configured to obtain N legal tender prices corresponding to the N types of virtual currencies respectively; and a first determining unit, configured to determine the head user according to the N legal tender prices corresponding to the N types of virtual currencies, and a number of the N types of virtual currencies occupied by each user in the blockchain system.

In a possible implementation of the embodiments of the present disclosure, the estimating module 34 includes: a second determining unit, configured to determine a first score of a target virtual currency according to a ratio of the transaction data corresponding to the target virtual currency in the current preset time period to the total transaction data corresponding to the M types of virtual currencies in the current preset time period; a third determining unit, configured to determine a second score of the target virtual currency according to a current price change value of the target virtual currency; and a fourth determining unit, configured to determine a market value corresponding to the target virtual currency according to the first score, the second score, and a weight corresponding to the first score and a weight corresponding to the second score.

Moreover, in a possible implementation of the embodiments of the present disclosure, the estimating module 34 includes: an estimating unit, configured to estimate market values of the N types of virtual currencies respectively.

Furthermore, in a possible implementation of the embodiments of the present disclosure, the above apparatus further includes: a third determining module, configured to determine a target virtual currency to be recommended to the user according to the market values of the N types of virtual currencies.

In a possible implementation of the embodiments of the present disclosure, the above apparatus further includes: a fourth determining module, configured to determine a first legal tender price corresponding to the virtual currency in the current preset time period, and a second legal tender price corresponding to the virtual currency in a previous preset time period adjacent to the current preset time period; and a fifth determining module, configured to determine the current price change value of the virtual currency according to the first legal currency price and the second legal currency price.

In a possible implementation of the embodiments of the present disclosure, the above apparatus further includes: a sixth determining module, configured to determine a new block in the blockchain system; and a seventh determining module, configured to determine the transaction information of the blockchain system in the current preset time period according to the transaction information of the new block in the current preset time period.

It should be noted that, the foregoing explanation of the embodiment of the virtual currency value estimation method shown in FIG. 1 and FIG. 2 is also applicable for the virtual currency value estimation apparatus 30 of this embodiment, and details are not described herein again.

With the virtual currency value estimation method according to embodiments of the present disclosure, historical transaction information of a blockchain system is obtained, a head user in the blockchain system is determined according to the user identifier corresponding to the transaction and the amount of the virtual currency used in the transaction, transaction data of the head user in a current preset time period is determined according to transaction information of the blockchain system in the current preset time period. Furthermore, according to the transaction data in the current preset time period and the current price change value of the virtual currency, the first score and the second score corresponding to the target virtual currency are determined, and a weight of the first score and a weight of the second score are set appropriately to estimate the market value of the target virtual currency. Therefore, the head user in the blockchain system is determined based on the historical transaction information of the blockchain system, and then the market value of the virtual currency can be estimated based on the transaction data of the head user and the current price change value of the virtual currency, thereby realizing real-time prediction of the value trend of virtual currencies and reducing the investment risk of users.

To achieve the above embodiments, the present disclosure further provides an electronic device.

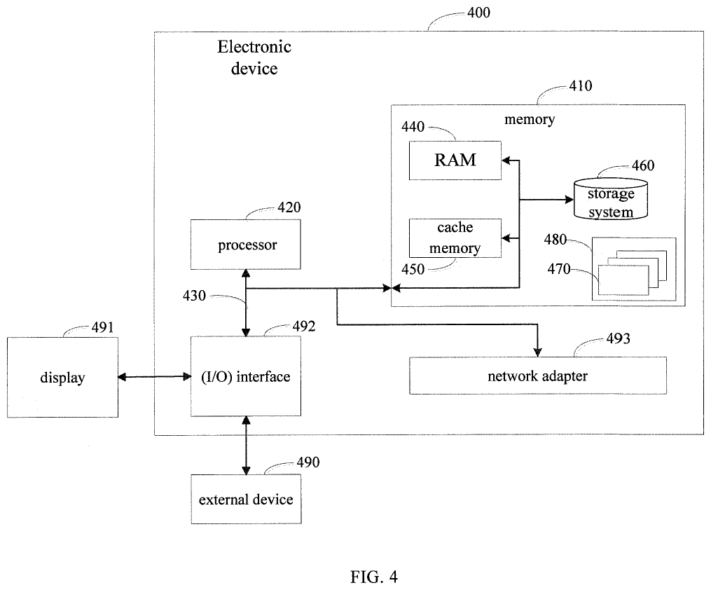

FIG. 4 is a schematic diagram of an electronic device according to an embodiment of the present disclosure.

As illustrated in FIG. 4, the above apparatus 400 includes: a memory 410, a processor 420, and a bus 430 connecting different components, including the memory 410 and the processor 420. The memory 410 has computer programs stored thereon, when the program is executed by the processor 420, the virtual currency value estimation method according to embodiments of the present disclosure.

The bus 430 represents one or more of several types of bus architectures, including a memory bus or a memory control bus, a peripheral bus, a graphic acceleration port (GAP) bus, a processor bus, or a local bus using any bus architecture in a variety of bus architectures. For example, these architectures include, but are not limited to, an industry standard architecture (ISA) bus, a micro-channel architecture (MCA) bus, an enhanced ISA bus, a video electronic standards association (VESA) local bus, and a peripheral component interconnect (PCI) bus.

Typically, the computing device 400 may include multiple kinds of computer-readable media. These media may be any storage media accessible by the computing device 400, including transitory or non-transitory storage medium and movable or unmovable storage medium.

The memory 410 may include a computer-readable medium in a form of volatile memory, such as a random access memory (RAM) 440 and/or a high-speed cache memory 450. The computing device 400 may further include other transitory/non-transitory storage media and movable/unmovable storage media. In way of example only, the storage system 460 may be used to read and write non-removable, non-volatile magnetic media (not shown in the FIG. 4, commonly referred to as “hard disk drives”). Although not illustrated in FIG. 4, it may be provided a disk driver for reading and writing movable non-volatile magnetic disks (e.g. “floppy disks”), as well as an optical driver for reading and writing movable non-volatile optical disks (e.g. a compact disc read only memory (CD-ROM, a digital video disc read only Memory (DVD-ROM), or other optical media). In these cases, each driver may be connected to the bus 430 via one or more data medium interfaces. The memory 410 may include at least one program product, which has a set of (for example at least one) program modules configured to perform the functions of embodiments of the present disclosure.

A program/application 480 with a set of (at least one) program modules 470 may be stored in the memory 410, the program modules 470 may include, but not limit to, an operating system, one or more application programs, other program modules and program data, and any one or combination of above examples may include an implementation in a network environment. The program modules 470 are generally configured to implement functions and/or methods described in embodiments of the present disclosure.

The computing device 400 may also communicate with one or more external devices 490 (e.g., a keyboard, a pointing device, a display 491, and etc.) and may also communicate with one or more devices that enables a user to interact with the computer system/server 400, and/or any device (e.g., a network card, a modem, and etc.) that enables the computer system/server 12 to communicate with one or more other computing devices. This kind of communication can be achieved by the input/output (I/O) interface 492. In addition, the device 400 may be connected to and communicate with one or more networks such as a local area network (LAN), a wide area network (WAN) and/or a public network such as the Internet through a network adapter 493. As shown, the network adapter 493 communicates with other modules of the device 400 over bus 430. It should be understood that although not shown, other hardware and/or software modules may be used in combination with the device 400, which including, but not limited to, microcode, device drivers, redundant processing units, external disk drive arrays, RAID systems, tape drives, as well as data backup storage systems and the like.

The processor 420 can perform various functional applications and data processing by running programs stored in the memory 410.

It should be noted that, for the implementation process and technical principle of the electronic device in this embodiment, refer to the foregoing explanation of the virtual currency value estimation method in the embodiment of the present disclosure, which is not repeated herein.

With the electronic device, the virtual currency value estimation method according to embodiments of the present disclosure is implemented, historical transaction information of a blockchain system is obtained, a head user in the blockchain system is determined according to the user identifier corresponding to the transaction and the amount of the virtual currency used in the transaction, transaction data of the head user in a current preset time period is determined according to transaction information of the blockchain system in the current preset time period, and a market value of the virtual currency is estimated based on the transaction data in the current preset time period and a current price change value of the virtual currency. Therefore, the head user in the blockchain system is determined based on the historical transaction information of the blockchain system, and then the market value of the virtual currency can be estimated based on the transaction data of the head user and the current price change value of the virtual currency, thereby realizing real-time prediction of the value trend of virtual currencies and reducing the investment risk of users.

In order to implement the above embodiments, the present disclosure also provides a computer-readable storage medium.

The computer-readable storage medium stores a computer program thereon, and when the program is executed by a processor, the virtual currency value estimation method described according to the embodiments of the present disclosure is implemented.

It should be understood that each part of the present disclosure may be realized by the hardware, software, firmware or their combination. In the above embodiments, a plurality of steps or methods may be realized by the software or firmware stored in the memory and executed by the appropriate instruction execution system. For example, if it is realized by the hardware, likewise in another embodiment, the steps or methods may be realized by one or a combination of the following techniques known in the art: a discrete logic circuit having a logic gate circuit for realizing a logic function of a data signal, an application-specific integrated circuit having an appropriate combination logic gate circuit, a programmable gate array (PGA), a field programmable gate array (FPGA), etc.

In the present disclosure, the terms “install”, “couple”, “connect” and the like shall be understood in a broad sense unless otherwise specified and defined, for example, they may be fixed connections, detachable connections, or integrated into one. It can also be a mechanical connection or an electrical connection. It can be directly connected or indirectly connected through an intermediate medium. It can be the internal connection of two elements or the interaction relation between two elements, unless it is clearly defined otherwise. For those of ordinary skill in the art, the specific meanings of the above terms in the present disclosure can be understood according to specific situations.

Reference throughout this specification to “an embodiment,” “some embodiments,” “an example,” “a specific example,” or “some examples,” means that a particular feature, structure, material, or characteristic described in connection with the embodiment or example is included in at least one embodiment or example of the present disclosure. The appearances of the above phrases in various places throughout this specification are not necessarily referring to the same embodiment or example of the present disclosure. Furthermore, the particular features, structures, materials, or characteristics may be combined in any suitable manner in one or more embodiments or examples. In addition, different embodiments or examples and features of different embodiments or examples described in the specification may be combined by those skilled in the art without mutual contradiction.

Although embodiments of present disclosure have been shown and described above, it should be understood that above embodiments are just explanatory, and cannot be construed to limit the present disclosure, for those skilled in the art, changes, alternatives, and modifications can be made to the embodiments without departing from spirit, principles and scope of the present disclosure.

What is claimed is:

1. A virtual currency value estimation method, comprising:
obtaining historical transaction information of a blockchain system, wherein the historical transaction information comprises a user identifier corresponding to a transaction and an amount of virtual currency used in the transaction;
determining a head user in the blockchain system according to the user identifier corresponding to the transaction and the amount of the virtual currency used in the transaction;
determining transaction data of the head user in a current preset time period according to transaction information of the blockchain system in the current preset time period; and
estimating a market value of the virtual currency based on the transaction data in the current preset time period and a current price change value of the virtual currency.

2. The method according to claim 1, wherein the blockchain system comprises N types of virtual currencies;
the historical transaction information further comprises: a type of the virtual currency used in the transaction; and
determining the head user in the blockchain system comprises:
obtaining N legal tender prices corresponding to the N types of virtual currencies respectively; and
determining the head user according to the N legal tender prices corresponding to the N types of virtual currencies and a number of the N types of virtual currencies occupied by each user in the blockchain system.

3. The method according to claim 1, wherein the transaction data of the head user in the current preset time period comprises transaction data corresponding to M types of virtual currencies in the current preset time period, and M is an integer less than or equal to N; and
estimating the market value of the virtual currency comprises:
determining a first score of a target virtual currency according to a ratio of transaction data corresponding to the target virtual currency in the current preset time period to total transaction data corresponding to the M types of virtual currencies in the current preset time period;
determining a second score of the target virtual currency according to a current price change value of the target virtual currency; and
determining a market value corresponding to the target virtual currency according to the first score, the second score, and a weight corresponding to the first score and a weight corresponding to the second score.

4. The method according to claim 1, wherein estimating the market value of the virtual currency comprises:
estimating market values of the N types of virtual currencies respectively; and
after estimating the market value of the virtual currency, the method further comprises:
determining a target virtual currency to be recommended to the user according to the market values of the N types of virtual currencies.

5. The method according to claim 1, before estimating the market value of the virtual currency, further comprising:
determining a first legal tender price corresponding to the virtual currency in the current preset time period, and a second legal tender price corresponding to the virtual currency in a previous preset time period adjacent to the current preset time period; and
determining the current price change value of the virtual currency according to the first legal tender price and the second legal tender price.

6. The method according to claim 1, before determining the transaction data of the head user in the current preset time period, further comprising:
determining a new block in the blockchain system; and
determining the transaction information of the blockchain system in the current preset time period according to transaction information of the new block in the current preset time period.

7. A virtual currency value estimation apparatus, comprising:
one or more processors;
a memory storing instructions executable by the one or more processors;
wherein the one or more processors are configured to:
obtain historical transaction information of a blockchain system, wherein the historical transaction information comprises a user identifier corresponding to a transaction and an amount of virtual currency used in the transaction;
determine a head user in the blockchain system according to the user identifier corresponding to the transaction and the amount of the virtual currency used in the transaction;
determine transaction data of the head user in a current preset time period according to transaction information of the blockchain system in the current preset time period; and
estimate a market value of the virtual currency based on the transaction data in the current preset time period and a current price change value of the virtual currency.

8. The apparatus according to claim 7, wherein the blockchain system comprises N types of virtual currencies;
the historical transaction information further comprises: a type of virtual currency used in the transaction; and
the one or more processors are configured to:
obtain N legal tender prices corresponding to the N types of virtual currencies respectively; and
determine the head user according to the N legal tender prices corresponding to the N types of virtual currencies, and a number of the N types of virtual currencies occupied by each user in the blockchain system.

9. The apparatus according to claim 7, wherein the transaction data of the head user in the current preset time period comprises transaction data corresponding to M types of virtual currencies in the current preset time period, and M is an integer less than or equal to N; and
the one or more processors are configured to:
determine a first score of a target virtual currency according to a ratio of the transaction data corresponding to the target virtual currency in the current preset time period to the total transaction data corresponding to the M types of virtual currencies in the current preset time period;
determine a second score of the target virtual currency according to a current price change value of the target virtual currency; and
determine a market value corresponding to the target virtual currency according to the first score, the second score, and a weight corresponding to the first score and a weight corresponding to the second score.

10. The apparatus according to any one of claim 7, wherein the one or more processors are configured to:
estimate market values of the N types of virtual currencies respectively; and
the one or more processors are further configured to:
determine a target virtual currency to be recommended to the user according to the market values of the N types of virtual currencies.

11. The apparatus according to claim 7, comprising:
determine a first legal tender price corresponding to the virtual currency in the current preset time period, and a second legal tender price corresponding to the virtual currency in a previous preset time period adjacent to the current preset time period; and
determine the current price change value of the virtual currency according to the first legal tender price and the second legal tender price.

12. The apparatus according to claim 7, comprising:
determine a new block in the blockchain system; and
determine the transaction information of the blockchain system in the current preset time period according to the transaction information of the new block in the current preset time period.

13. A computer-readable storage medium having a computer program stored thereon, wherein when the program is executed by a processor, a virtual currency value estimation method is implemented, and the virtual currency value estimation method comprises:
obtaining historical transaction information of a blockchain system, wherein the historical transaction information comprises a user identifier corresponding to a transaction and an amount of virtual currency used in the transaction;
determining a head user in the blockchain system according to the user identifier corresponding to the transaction and the amount of the virtual currency used in the transaction;
determining transaction data of the head user in a current preset time period according to transaction information of the blockchain system in the current preset time period; and
estimating a market value of the virtual currency based on the transaction data in the current preset time period and a current price change value of the virtual currency.
